(19) United States
(12) Patent Application Publication
(10) Pub. No.: US 2007/0200702 A1
(43) Pub. Date: Aug. 30, 2007

(54) APPARATUS WITH INTEGRATED RFID READING/INTERNET COMMUNICATION FUNCTION, AND METHOD THEREOF

(75) Inventor: Sang-Hwa Chung, Busan (KR)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Pusan National University Industry-University Cooperation Foundation

(21) Appl. No.: 11/678,080

(22) Filed: Feb. 23, 2007

(30) Foreign Application Priority Data
Feb. 24, 2006 (KR) 2006-18393

(51) Int. Cl. G08B 13/14; G08B 1/00

(52) U.S. Cl. 340/572.1; 340/531

(57) ABSTRACT

An apparatus with integrated RFID reading/internet communication functions and a method thereof are disclosed. An apparatus with integrated RFIF reading/internet communication functions includes a RFID read part comprising a RF module controller that controls a RFID module for receiving/transmit data from a RFID tag, a first processor core that controls an operation of the RFID read part and that sends data, and a first dynamic memory controller that controls a first dynamic memory in communication with the first processor core; and an internet communication part comprising an Ethernet controller that performs internet communication based on an Ethernet interface, a second processor core that controls an operation of the internet communication part and that sends data together with the RFID read part, and a second dynamic memory controller that controls a second dynamic memory in communication with the second processor core.

### CROSS REFERENCE TO RELATED APPLICATION

This application claims the benefit of the Patent Korean Application No. 10-2006-18393, filed on Feb. 24, 2006, which are hereby incorporated by reference as if fully set forth herein.

### BACKGROUND OF THE DISCLOSURE

1. Field of the Disclosure

The present invention relates to an apparatus with integrated RFID reading/internet communication functions, and a method thereof. More particularly, the present invention relates to an apparatus that includes a first processor for RFID reading and a second processor for internet communication to read data and to transmit the data to a main server via internet communication without a local host.

2. Discussion of the Related Art

In general, RFID (Radio Frequency Identification) technology is one of non-contact identification technologies which can uses a RF (Radio Frequency) to identify ID (or Data) and thus can recognize objects. A RFID technology includes a RFID tag, a RFID reader and a computing system. The RFID tag stores data and the RFID reader reads the data of the RFID tag. The computing system processes the data read by the RFID reader. For example, a RFID reader reads data from a RFID tag attached to a person, a vehicle, a product, a traffic pass card or the like to identify their ID. Hence, the computing system processes the data, to recognize objects and perform work required.

Commonly, a RFID tag includes a transponder chip made of a semiconductor and an antenna. A passive RFID tag receives energy from a wave signal of a RFID reader. An active RFID tag receives energy from a power (especially, a battery) provided therein to transmit its stored data to a RFID. Since an active RFID tag has its own power, a distance, in other words, reading range is long. However, the price of the active RFID tag is relatively high and its battery should be replaced quite often. Whereas, a passive RFID tag converts a wave signal of a RFID reader to its power and has a short reading range. However, the price of the passive RFID tag is relatively low and usable semi-permanently.

By the way, the radio frequency used in RFID technology may be LF (Low Frequency) with a frequency range of 123 kHz, HF (High Frequency) with a frequency range of 13.56 MHz, UHF (Ultra-High Frequency) with a frequency range of 433/900 MHz and MW (Microwave) with a frequency range of 2.4 GHz. Each frequency range has its advantages or disadvantages according to its technical characteristics. For example, 900 MHz of UHF is mainly used in the passive RFID tag and 433 MHz is mainly used in the active RFID tag.

The RFID reader receives data of a RFID tag within the RFID reading range and reads the data. Hence, the RFID reader transmits the read data to the computing system. For example, if the computing system is configured of a local host and a main server, the RFID reader reads the data from the RFID tag via an interface such as a serial interface and Ethernet interface. And then, the RFID reader transmits the data to the local host. Hence, the local host transmits the data received from the RFID reader to the main server via an internet based on a TCP/IP. Hence, the main server uses the data to process a predetermined work such as ERP (Enterprise Resource Planning), SCM (Supply Chain Management), CRM (Customer Relationship Management) or the like.

However, the conventional RFID reader does not have a function of directly transmitting data to the main server via an internet. Thus, the conventional RFID reader should send data to the main server via the local host and if then, an auxiliary device such as a network for connecting RFID readers to the local host should be necessarily provided. Thereby, even in case that only a small number of RFID readers are used in a predetermined space, a local host such as a computer and a network should be provided for internet communication and thus the conventional RFID reader has a problem of economical or physical burden to a consumer.

Furthermore, the conventional RFID reader only simply collects data and transmits the data to the local host. Thus, it is impossible for the conventional RFID reader to process the data by itself. All of the data processing is performed by the local host and a middle ware of the main server. If a lot of data should be processed, the local host as well as the main server may be overloaded too much to delay its services.

### SUMMARY OF THE DISCLOSURE

Accordingly, the present invention is directed to an apparatus with integrated RFID reading/internet communication functions, and a method thereof.

An object of the present invention is to provide an apparatus with integrated RFID reading/internet communication functions, which can read data from a RFID tag and can transmit the read data to a main server via internet communication.

Another object of the present invention is to provide an apparatus with integrated RFID reading/internet communication functions, which has a processor core for RFID reading and another processor core for internet communication and can separately process a RFID reading function and an internet communication function to enhance job process efficiency without communication efficiency deterioration.

A further object of the present invention is to provide an apparatus with integrated RFID reading/internet communication functions, which is a SoC type.

Additional advantages, objects, and features of the disclosure will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, an apparatus with integrated RFIF reading/internet communication functions includes a RFID read part and an internet communication part. The RFID read part includes a RF module controller that controls a RFID module for receiving/transmit data from a RFID tag, a first processor core that controls an operation of the RFID read part and that sends data, and a first dynamic memory controller that controls a first dynamic memory in communication with the first processor core. The internet communication part includes an Ethernet controller that performs internet communication based on an Ethernet interface, a second processor core that controls an operation of the internet communication part and that sends data together with the RFID read part, and a second dynamic memory controller that controls a second dynamic memory in communication with the second processor core.

The apparatus with integrated RFIF reading/internet communication functions may further includes a data transmission memory in communication with the RFID read part and the internet communication part, which stores the data transmitted between the RFID read part and the internet communication part. The RFID read part and the internet communication part performing data transmission by using the data transmission memory.

The RFID read part and the internet communication part is configured of a SoC (System on Chip). The SoC is that a RFID reading function and an internet communication function are integrated in one chip.

In another aspect of the present invention, a method of an apparatus with integrated RFID reading function/internet communication functions includes (a) step that a RF module controller processes data received from a RFID tag; (b) step that the RF module controller transmits the processed data to a first processor core; (c) step that the first processor core stores the data in data transmission memory and generates interrupt in a second processor core; (d) step that the second processor core reads the data stored in the data transmission memory; and (e) step that the second processor core transmits the read data to an internet via an Ethernet controller.

In a further aspect of the present invention, a method of an apparatus with integrated RFID reading function/internet communication functions includes (a) step that an Ethernet controller transmits a job command transmitted from an internet to a second processor core; (b) step that the second processor core stores the job command in data transmission memory and generates interrupt in the first processor core; (c) step that the first processor core reads the job command stored in the data transmission memory; and (d) step that the first processor core controls a RF module controller based on the job command.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure. In the drawings:

FIG. 1 is a diagram illustrating a structure of an apparatus with integrated RFID reading/internet communication functions according to the present invention;

FIG. 2 is a block view illustrating a function of data transmission memory provided in the apparatus with integrated RFIF reading/internet communication functions according to the present invention;

FIG. 3 is a flow chart of a method of an apparatus with integrated RFID reading function/internet communication functions according to an embodiment of the present invention, illustrating a process of transmitting data read from the RFID tag via an internet; and

FIG. 4 is a flow chart of a method of an apparatus with integrated RFID reading function/internet communication functions according to another embodiment of the present invention, illustrating a process that a RFID read part performs a job command transmitted from the internet.

### DESCRIPTION OF SPECIFIC EMBODIMENTS

Reference will now be made in detail to the specific embodiments of the present invention, examples of which are illustrated in the accompanying drawings. Wherever possible, the same reference numbers will be used throughout the drawings to refer to the same or like parts.

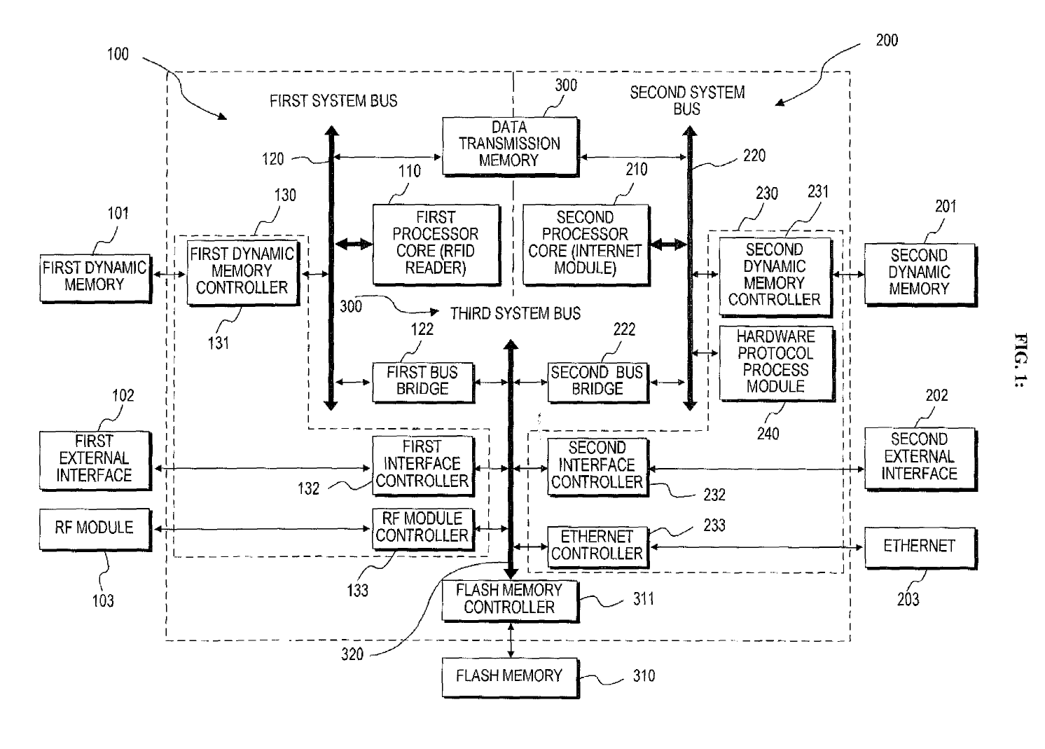

FIG. 1 illustrates a structure of an apparatus with integrated RFIF reading/internet communication functions according to the present invention. As shown in FIG. 1, an apparatus with integrated RFIF reading/internet communication functions according to the present invention has a structure of a dual processor core. The apparatus for integrating a RFIG reading function/internet communication function according to the present invention mainly includes a RFID read part 100, an internet communication part 200 and other hardware including a data transmission memory. The RFID read part 100 receives data from a RFID tag and reads the data. The internet communication part 200 performs internet communication based on a TCP/IP.

First of all, a RFID reading function according to the present invention will be described.

The RFID read part 100 includes a first processor core 110, a first dynamic memory controller 131, a first interface controller 132, a RF module controller 133 and a system bus that connects its components. Thus, the RFID read part 100 records/reads data of a RFID tag.

The first processor core 110 is a processor core for RFID reading as a RFID reader. In an initial operation, the first processor core 110 reads RFID reader software from a flash memory 310 and performs the RFID reading functions of the RFID read part 100. The first processor core 110 is connected to a first system bus 120 and the first system bus 120 is connected to a first dynamic memory controller 131. The first dynamic memory controller 131 is a controller that records/reads data of a first dynamic memory 101. A SDRAM or DDR-SDRAM may be used as the first dynamic memory 101 and such a dynamic RAM has an advantage of high capacitance as well as fast operation speed, even though its data is lost when the power is off.

The structure of the system bus according to the present invention is substantially similar to that of a normal embedded processor. Specifically, the system bus includes a primary system bus connected to a fast external device, in other words, a terminal or hardware and a secondary system bus connected to a relatively slow external device or hardware. These system buses may be connected via a bus bridge. A first system bus 120 uses a primary bus. The first system bus 120 is connected to the first processor core 110 and the first dynamic memory controller 131, which are described above, and also to a data transmission memory 300, which will be described later. The first system bus 120 is connected to a third system bus 320 via a first bus bridge 122. The third system bus 320 uses a secondary system bus. The first interface 132, the RF module controller 133 and a flash memory controller 311 are connected to the third system bus 320.

The first interface controller 132 controls communication with an external terminal (device) via a first external communication interface 102. The first external communication may be a serial communication such as RS232, RS422 RS485 or USB, or a parallel communication such as SPP, ECP or EPP. Thus, a user can monitor/output operation conditions of the first processor core 110.

The RF module controller 133 controls a RF module 103 to enable RF communication. The RF module controller 133 processes predetermined jobs by using hardware. The jobs may be sending/receiving data to/from a RFID tag within a radio frequency (for example, 433 MHz) and data security. Thereby, the software processing load of the first processor core 110 may be reduced and the security protocol processing load may be removed. The job of sending/receiving data which is processed in hardware by the RF controller 133 will be described as follows.

Firstly, when the RFID reader sends data to a RFID tag, the RF module controller 133 adds a CRC (Cyclic Redundancy Check) code to the data to make the digital data corresponding to a RF communication protocol. The RF module controller converts the CRC code added digital data to a digital signal based on a baseband modulation. Hence, the RF module controller 133 adds a preamble to the digital signal and transmits the preamble added digital signal to the RF module 103. Finally, the RF module 103 transmits the data to the RFID tag under the control of the RF module controller 133.

Whereas, when the RFID reader receives data from a RFID tag, the RF module controller 133 checks a preamble of the data received via RF module 103 and identifies whether the data is normal. If the preamble is not normal, the RF module controller 133 determines that the data is abnormal and ignores the data. If the preamble is normal, the RF module controller 133 removes the preamble from the data. Also, the RF module controller 133 demodulates the digital signal and generates digital data. Hence, the RF module controller 133 checks a CRC code to identify whether the data is received normally. If an error is found in the CRC code, the RF module controller 133 notifies the first processor core 110 of the error. If there is no error in the CRC code, the RF module controller 133 transmits the digital data to the first processor core 110 as received data.

As described above, the RF module controller 133 performs data encoding/decoding, and preamble/CRC code generating and checking by using hardware. Thus, the timing of sending/receiving the RF communication protocol may be precise and also the software processing jobs are lessened to reduce the processing load of the processor core.

Furthermore, the RF module controller 133 according to the embodiment of the present invention performs data security as well. In RF communication, a security protocol should be used to support data security. Commonly, security protocol processing generates lots of load on a processor. The RF module controller 133 according to the present invention processes security protocol by using hardware and thus security protocol processing load of a processor may be removed.

Lastly, the flash memory controller 311 records/reads data in a flash memory 310. The operation speed of the flash memory 310 is relatively slow, compared with the dynamic flash. However, the data of the flash memory 310 may not disappear when the power off. In this embodiment of the present invention, the flash memory 310 is used to store a program code.

Next, the internet communication function according to the present invention will be described.

An embedded processor processes TCP/IP to support an internet based on TCP/IP in a general embedded system. Thereby, lots of load is generated on the processor only to deteriorate the system/communication efficiency. Also, a security protocol should be used to send/receive data securely on an internet. The security protocol takes a lot of jobs. Thus, if a security protocol is added, more processing load is caused to the processor.

According to the present invention, a processor core for processing RCP/IP protocol and security protocol, which is a second processor core, is additionally provided to support a secured internet communication. To lessen the processing load of the processor, software and hardware perform job processing in communication with each other.

As shown in FIG. 1, the internet communication part 200 includes a second processor core 210, a second dynamic memory controller 231, a hardware protocol processing module 240, a second interface controller 232, an Ethernet controller 233 and a system bus for connecting the other components each other.

The second processor core 210 is a processor core for internet communication. Like the first processor core 110, the second processor core 210 reads an internet communication software from a flash memory 310 and performs internet communication by using internet communication software. The second processor core 210 is connected to a second bus system 220. Also, a second memory controller 23 and the hardware protocol processing module 240 are connected to the second bus system 220

The second dynamic memory controller 231 is a controller that records/reads data of the second dynamic memory 201. The second dynamic memory 201 is substantially the same as the first dynamic memory 201 described before.

The hardware protocol processing module 240 processes security protocol and some jobs of TCP/IP. Lots of numeral calculations are required to process the security protocol. Thus, the hardware protocol process module 240 processes the security protocol fast by using hardware and also removes load of the processor for processing security protocol. The processor has too many jobs to process in case of TCP/IP. Thus, some jobs, which affects a communication function and which can gain benefits if hardware processes them, are processed by the hardware protocol processing module 240. Thereby, the TCP/IP processing load of the processor may be lessened and communication efficiency may be enhanced. The hardware protocol processing module 240 is closely connected to the second processor core 210 via the second system bus which is a primary system bus 220. Thereby, the software and hardware are in communication with each other fast to process protocol.

The second processor core 210, the second dynamic memory controller 231, the hardware protocol processing module 240 and the data transmission memory 300 are connected to the second system bus 220. The second system bus 220 is connected to the third system bus 320 via a second bus bridge 222. The third system bus 320 is connected to the first interface controller 132, the RF module controller 133 and the flash memory 310. Also, the third system bus 320 is connected to the second interface controller 232 and the Ethernet controller 233.

The second interface controller 232 is substantially similar to the first interface controller 132 and it is used when an operation condition of the second processor core 210 is monitored or outputted.

The Ethernet controller 233 controls an external physical layer chip so that data may be transmitted and received via an internet based on an Ethernet interface. When transmitting the data, the Ethernet controller 233 transmits a data packet having TCP/IP and security protocol processed to an internet. When receiving the data, the Ethernet controller 233 transmits the received data packet to an upper layer such as the hardware protocol process module to process protocol.

Next, the data transmission memory 300 and the flash memory 311 are described, which the RFID part and the internet communication part share.

According to the present invention, the RFID read part 100 and the internet communication part 200 have the processor cores 110 and 210, respectively, and share the data transmission memory 300 and the flash memory 310. The data transmission memory 300 is connected to the first system bus 120 and the second system bus 220, in communication with the first processor core 110 and the second processor core 210. The flash memory 310 communicates with the first processor core 110 and the second processor core 210 via the third system bus 320 connected to the first system bus 120 and the second system bus 220. As described above, the first processor core 110 and the second processor core 210 share the data transmission memory 300 and the flash memory 310. However, the first processor core 110 and the second processor core 210 do not share their data and thereby they are not a SMP system (Symmetric Multi-processing system). The two processor cores 110 and 210 are operated separately.

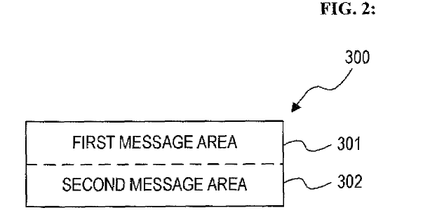

The data transmission memory 300 is used to transmit messages including data between the first processor core 110 and the second processor core 210. The data transmission memory 300 includes a first message area 301 and a second message area 302. In the first message area 301, the RFID read part 100 transmits a message to the internet communication part 200. In the second message area 302, the internet communication part 200 transmits a message to the RFID read part 100 (see FIG. 2). When the RFID read part transmits a message to the internet communication part 200, the RFID read part 10 records (or stores) the message in the first message area 301 and then notifies the internet communication part 200 of the message by interrupt. Hence, the internet communication part 200 reads the message in the first message area 301 and transmits the message to a main server via an internet. Whereas, when the internet communication receives a job command from the main server via an internet and transmits the job command to the RFID read part 100, the internet communication part 200 records, in other words, stores the message in the second message area 302 and notifies the RFID read part 100 of the message by interrupt. Hence, the RFID read part 100 reads a job command data in the second message area 302 to perform a command corresponding to the job command data.

The flash memory 310 communicates with the RFID read part 100 and the internet communication part 200 via the flash memory controller 311 connected to the third system bus 320, as mentioned above. According to this embodiment, the flash memory 310 is used for the RFID read part and the internet communication part 200 to share their storage space, not to share their data. Hence, the flash memory 310 stores a program code for the first processor core 110 and the second processor core 210. The flash memory 310 copies each program code of the first and second dynamic memory 101 and 201, unlike the first and second dynamic memory 101 and 201 which performs their programs, respectively. Thus, it is possible that the first and second processor cores 110 and 210 to store and share their program codes in separate areas within the flash memory 310, respectively. Since the two processor cores 110 and 210 share the flash memory, one flash memory is needed with respect to hardware. Thereby, it is possible to reduce the number of external I/O pins for supporting the flash memory interface.

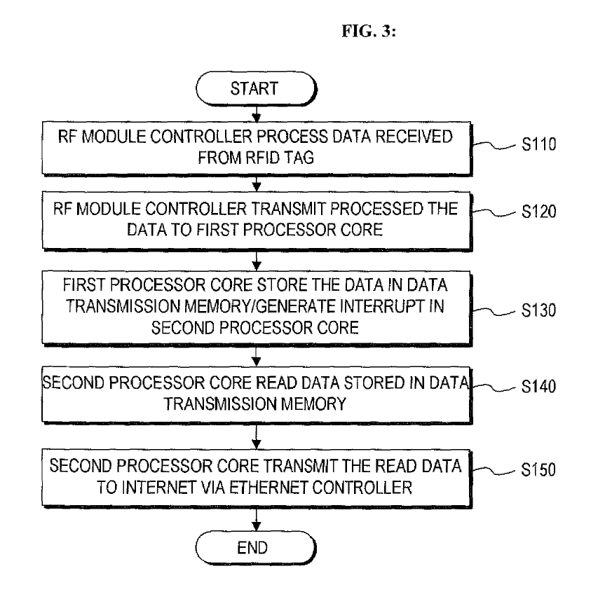

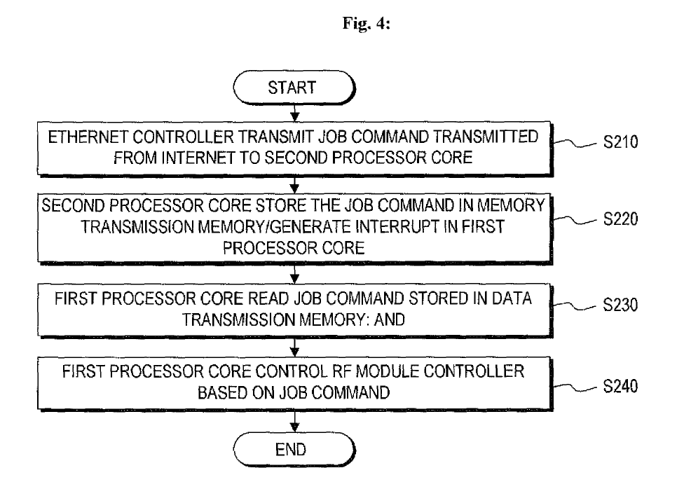

In reference to FIGS. 3 and 4, a method for integrating/performing the RFID reading function and the internet communication function according to the present invention will be described. Detailed operation or performance of the method can be explained, referring to the apparatus for integrating the RFID function and the internet communication function according to the present invention described above.

FIG. 3 is a flow chart of a method for integrating and performing the RFID reading function and the internet communication function, illustrating a process that data read from a RFID tag is transmitted to an internet.

Once the RF module controller 133 receives data from a RFID tag, the RF module controller 133 checks a preamble of the data to identify whether the data is normal. If the preamble of the data is normal, the RF module controller 133 removes the preamble from the data and demodulates the data to digital data. Hence, the RF module controller 133 checks a CRC code of the demodulated data to identify whether the received data is normal. (S110). If the received data is normal, the RF module controller 133 transmits the data to the first processor core 110 (S120). The first processor core 110 stores the data transmitted from the RF module controller 133 in the data transmission memory 300. After that, the first processor core 110 generates interrupt to the second processor core 210 and notifies the second processor core 210 that the data is stored in the data transmission memory (S130). The second processor core 210 reads the data stored in the data transmission memory (S140) and transmits the read data to the internet via the Ethernet controller 203 (S150).

FIG. 4 is a flow chart of a method of the apparatus with integrated RFID reading/internet communication functions according to another embodiment of the present invention, illustrating a process that the RFID read part 100 performs a job command transmitted from an internet.

Once a job command is transmitted to the apparatus with integrated RFID reading/internet communication functions according to the present invention from a main server via the internet, the Ethernet controller 232 transmits the job command to the second processor core 210 (S210). The second processor core 210 stores the job command transmitted from the main server in the data transmission memory 300 and generates interrupt in the first processor core 110 to notify the first processor core 110 of the job command (S220). Hence, the first processor core 110 reads the job command stored in the data transmission memory 300 (S230). Thus, the first processor core 110 controls the RF module controller 133 based on the job command (S240). More specifically, if it receives a job command of transmitting predetermined data to the RFID tag from the main server, the first processor core 110 controls the RF module controller 133. Then, the RF module controller 133 adds a CRC code to the data corresponding to the job command and demodulates the data to a digital signal based on a baseband modulation. Hence, the RF module controller 133 adds a preamble to the digital signal and transmits the preamble added digital signal to the RFID tag.

Referring to the above preferred embodiments, the present invention is described in detail. Alternatively, the apparatus with integrated RFIF reading/internet communication functions may be adaptable to a terminal for management of physical distribution and to a physical distribution management system that acquires a RFID tag, and then it performs communication with a main server via an internet to manage a physical distribution.

According to the present invention, there may be following advantageous effects.

Firstly, the RFID read part and the internet communication part communicates with each other. Thereby, there is an advantageous effect that the data read from a RFID tag may be freely transmitted via an internet without any help of a local host.

Furthermore, the RFID read part according to the present invention has its processor core and the internet communication according to the present invention has its processor core and the processor cores are operated separately with separate local systems. Thereby, there is another advantageous effect that job processing efficiency may be enhanced without communication performance deterioration.

Still further, the apparatus having a RFID reading function and an internet communication function integrated is formed of one SoC (System-on-Chip) type processor and embedded in a terminal for RFID reading Thereby, there is a further advantageous effect that the size of the terminal may be small and transplantation of the apparatus into another terminal is relatively easy.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. An apparatus with integrated RFIF reading/internet communication functions comprising:
a RFID read part comprising a RF module controller that controls a RFID module for receiving/transmit data from a RFID tag, a first processor core that controls an operation of the RFID read part and that sends data, and a first dynamic memory controller that controls a first dynamic memory in communication with the first processor core; and
an internet communication part comprising an Ethernet controller that performs internet communication based on an Ethernet interface, a second processor core that controls an operation of the internet communication part and that sends data together with the RFID read part, and a second dynamic memory controller that controls a second dynamic memory in communication with the second processor core.

2. The apparatus with integrated RFIF reading/internet communication functions of claim 1, further comprising data transmission memory in communication with the RFID read part and the internet communication part, which stores the data transmitted between the RFID read part and the internet communication part.

3. The apparatus with integrated RFIF reading/internet communication functions of claim 2, wherein the data transmission memory comprises,
a first message area that stores data transmitted to the internet communication part by the RFID read part;
a second message area that stores data transmitted to the RFID read part by the internet communication part.

4. The apparatus with integrated RFIF reading/internet communication functions of claim 1, wherein the RF module controller performs RF communication process and data security by using hardware.

5. The apparatus with integrated RFIF reading/internet communication functions of claim 1, wherein the RFID read part and the internet communication part is configured of a SoC (System on Chip) in which a RFID reading function and an internet communication function are integrated in one chip.

6. The apparatus with integrated RFIF reading/internet communication functions of claim 1, wherein the internet communication part further comprises a hardware protocol process module that processes a RCP/IP and security protocol for internet communication under the control of second processor core.

7. The apparatus with integrated RFIF reading/internet communication functions of claim 1, wherein the first processor core and the first dynamic memory controller are connected to a first system bus, and the second processor core and the second dynamic memory controller are connected to a second bus, and the RF module controller and the Ethernet controller are connected to a third system but,
further wherein the first system bus communicates with the third system bus via a first bus bridge and the second system bus communicates with the third system bus via a second bus bridge.

8. The apparatus with integrated RFIF reading/internet communication functions of claim 7, wherein the third system bus is connected to a flash memory controller that controls a flash memory shared by the RFID read part and the internet communication part.

9. The apparatus with integrated RFIF reading/internet communication functions of claim 7, the third system bus is connected to a first interface controller for controlling a first external communication interface and a second interface controller for controlling a second external communication interface.

10. The apparatus with integrated RFIF reading/internet communication functions of claim 9, wherein the first interface controller monitors and outputs an operation of the first processor core, further wherein the second interface controller monitors and outputs an operation of the second processor core.

11. A method of an apparatus with integrated RFID reading function/internet communication functions comprising:
(a) step that a RF module controller processes data received from a RFID tag;
(b) step that the RF module controller transmits the processed data to a first processor core;
(c) step that the first processor core stores the data in data transmission memory and generates interrupt in a second processor core;
(d) step that the second processor core reads the data stored in the data transmission memory; and
(e) step that the second processor core transmits the read data to an internet via an Ethernet controller.

12. The method of an apparatus with integrated RFID reading function/internet communication functions of claim 11, wherein the (a) step comprises,
(a-1) step that the RF module controller checks a preamble of the data received by a RF module to identify whether the data is normal;
(a-2) step that the RF module controller removes the preamble from the data and demodulates the data to digital data if the preamble is normal;
(a-3) step that the RF module controller checks a CRC code of the demodulated data to identify whether the data is received normally; and
(a-4) step that the RF module controller transmits the data to the first processor core if the data is received normally.

13. A method of an apparatus with integrated RFID reading function/internet communication functions comprising:
(a) step that an Ethernet controller transmits a job command transmitted from an internet to a second processor core;
(b) step that the second processor core stores the job command in data transmission memory and generates interrupt in the first processor core;
(c) step that the first processor core reads the job command stored in the data transmission memory; and
(d) step that the first processor core controls a RF module controller based on the job command.

14. The method for integrating a RFID reading function/internet communication function of claim 13, further comprising steps after (d) step if the job command transmitted from the internet is a command for transmitting data to a RFID tag:
(e-1) step that the RF module controller adds a CRC code to the data;
(e-2) step that the RF module controller converts the CRC code added data to a digital signal via a baseband modulation;
(e-3) step that the RF module controller adds a preamble to the digital signal; and
(e-4) step that the RF module controller transmits the preamble added digital signal to a RFID tag via a RF module.
